(19) United States
(12) Patent Application Publication
(10) Pub. No.: US 2019/0389488 A1
(43) Pub. Date: Dec. 26, 2019

(54) SURROUNDINGS MONITORING DEVICE

(71) Applicant: TOYOTA JIDOSHA KABUSHIKI KAISHA, Toyota-shi (JP)

(72) Inventors: Yoshinori YAMADA, Nagakute-shi (JP); Masaki ITO, Toyota-shi (JP)

(73) Assignee: TOYOTA JIDOSHA KABUSHIKI KAISHA, Toyota-shi (JP)

(21) Appl. No.: 16/395,437

(22) Filed: Apr. 26, 2019

(30) Foreign Application Priority Data
Jun. 21, 2018 (JP) 2018-118137

(51) Int. Cl. B60W 50/14; G06K 9/00

(52) U.S. Cl. CPC B60W 50/14; G06K 9/00805; B60R 2300/60; B60R 2300/8093; B60R 2300/307; B60W 2050/146

(57) ABSTRACT

A surroundings monitoring device that includes: a display device that displays an own-vehicle display displaying a vehicle equipped with the surroundings monitoring device; a detection device that detects a potential hazard present near the vehicle; a processor; and a memory that is connected to the processor, the processor being configured to display on the display device a potential hazard display spanning from the own-vehicle display, or from a vicinity of the own-vehicle display on the display device, to a location of the display device corresponding to a direction in which the potential hazard detected by the detection device is present, the potential hazard display being distinct from display at other locations.

### CROSS-REFERENCE TO RELATED APPLICATION

This application is based on and claims priority under 35 USC 119 from Japanese Patent Application No. 2018-118137 filed on Jun. 21, 2018, the disclosure of which is incorporated by reference herein.

### BACKGROUND

### Technical Field

The present disclosure relates to a surroundings monitoring device.

### Related Art

Japanese Patent Application Laid-Open (JP-A) No. 2010-258705 discloses technology relating to a vehicle surroundings monitoring device. In this vehicle surroundings monitoring device, in cases in which it is difficult to see the shape of a potential hazard, this being an object that calls for caution, with the naked eye, for example due to the potential hazard being far away from the vehicle, the potential hazard is displayed enlarged on a head-up display, this being an image display device. When this is performed, the enlarged image displayed on the head-up display is displayed in a position that is not superimposed on the potential hazard actually seen by an occupant. The occupant is therefore able to see the shape of the potential hazard.

However, in the configuration of JP-A No. 2010-258705, in a state in which plural potential hazards are present, an enlarged image of each could be displayed on the head-up display. In such cases, due to the excessive amount of information, the occupant might be unable to intuitively recognize potential hazards that have been detected by the surroundings monitoring device and the directions of these potential hazards. There is accordingly room for improvement of the related art regarding this point.

### SUMMARY

An aspect of the disclosure is a surroundings monitoring device that includes: a display device that displays an own-vehicle display displaying a vehicle equipped with the surroundings monitoring device; a detection device that detects a potential hazard present near the vehicle; a processor; and a memory that is connected to the processor, the processor being configured to display on the display device a potential hazard display spanning from the own-vehicle display, or from a vicinity of the own-vehicle display on the display device, to a location of the display device corresponding to a direction in which the potential hazard detected by the detection device is present, the potential hazard display being distinct from display at other locations.

### BRIEF DESCRIPTION OF THE DRAWINGS

Exemplary embodiments of the present invention will be described in detail based on the following figures, wherein:

FIG. 1 is a schematic view illustrating an operational state of a surroundings monitoring device according to an exemplary embodiment, as viewed from the perspective of an occupant;

FIG. 2 is a schematic view illustrating an example of a display on a display device of a surroundings monitoring device according to an exemplary embodiment in a state in which potential hazards each have a low potential degree of influence on a vehicle;

FIG. 3 is a schematic view illustrating an example of a display on a display device of a surroundings monitoring device according to an exemplary embodiment in a state in which potential hazards each have a high potential degree of influence on a vehicle;

FIG. 4 is a schematic view illustrating an example of a display on a display device of a surroundings monitoring device according to an exemplary embodiment in a case in which numerous potential hazards are present nearby a vehicle;

FIG. 5 is a flowchart for explaining an example of display processing executed by a processor of a surroundings monitoring device according to an exemplary embodiment; and

FIG. 6 is a block diagram illustrating an example of a hardware configuration of a surroundings monitoring device.

### DETAILED DESCRIPTION

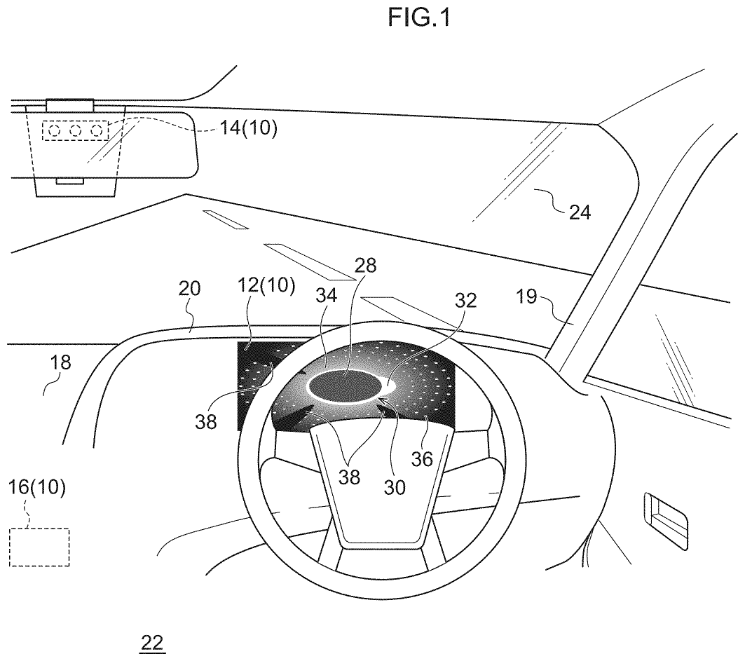

Explanation follows regarding an exemplary embodiment of a surroundings monitoring device, with reference to FIG. 1 to FIG. 6.

Overall Configuration

As illustrated in FIG. 1, a surroundings monitoring device 10 of the present exemplary embodiment is provided to a vehicle that is capable of autonomous driving, and includes a display panel 12, serving as an example of a display device, a detection device 14, and a controller 16. The display panel 12 is provided inside a meter cluster 20, described later, on an instrument panel 18. The instrument panel 18 is provided at the vehicle front of the interior of a vehicle cabin 22. Specifically, the instrument panel 18 is disposed at the upper side of a vehicle rear portion of a dash panel that partitions between the vehicle cabin 22 and a vehicle front section. A lower end portion of the dash panel is joined to a front end portion of a floor panel, and the floor panel configures a lower surface of the vehicle cabin 22. A cowl is joined to an upper end portion of the dash panel. The cowl supports a lower end portion of a front windshield 24. The front windshield 24 configures a front surface at the upper side of the vehicle cabin 22. The lower end portion of the front windshield 24 is disposed at an upper end portion of the instrument panel 18.

Front seats, these being vehicle front seats, are provided to the vehicle rear of the instrument panel 18. In the present exemplary embodiment, the front seat on the left side in a front section of the vehicle cabin 22 is a front passenger seat, and the front seat on the right side in the front section of the vehicle cabin 22 is a driving seat.

The instrument panel 18 is configured by an interior panel member extending along the vehicle width direction. Instrument panel reinforcement extending in an elongated shape along the vehicle width direction is provided to an upper portion of the interior (vehicle front side) of the instrument panel 18. The instrument panel 18 is attached to the instrument panel reinforcement at plural locations. Note that the instrument panel reinforcement is a pipe member made of metal, and the two length direction end portions of the instrument panel reinforcement are respectively fixed to the vehicle lower sides of a pair of front pillars 19 erected at left and right vehicle body side sections.

Display Panel

The above-mentioned meter cluster 20 is provided on the driving seat side of the instrument panel 18. The meter cluster 20 is provided projecting from an upper portion of the instrument panel 18 toward the vehicle upper side. The display panel 12 is provided inside the meter cluster 20 with its display face directed toward the vehicle cabin 22. As an example, the display panel 12 is configured by a liquid crystal panel, and an operation status of the surroundings monitoring device 10, a map of a car navigation system, and so on are displayed on the display panel.

Specifically, the operation status of the surroundings monitoring device 10 displayed on the display panel 12 is indicated by an own-vehicle display 28, a warning direction display 30, a nearby situation display 34, and potential hazard displays 38. Detailed explanation follows regarding each of these displays.

Own-Vehicle Display

The own-vehicle display 28 is displayed at substantially the vehicle vertical direction center of the display panel 12. As an example, the vehicle is schematically displayed in a dark color and in an elliptical shape with its length direction substantially along the vehicle width direction. The own-vehicle display 28 is basically set so as not to move within the display panel 12.

Warning Direction Display

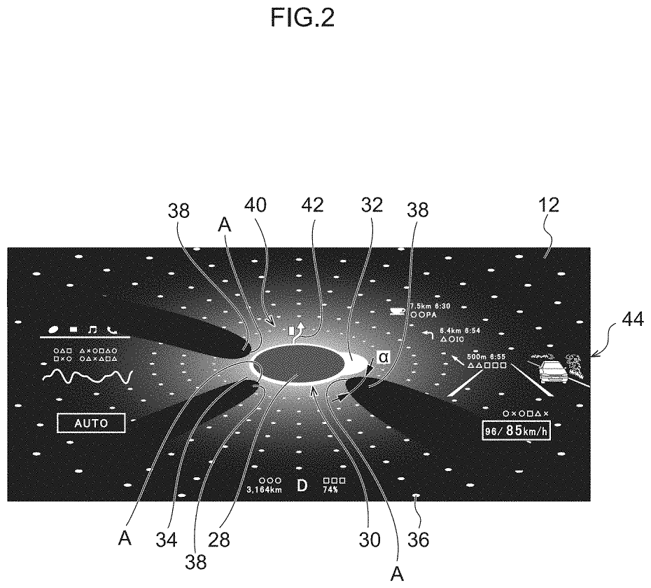

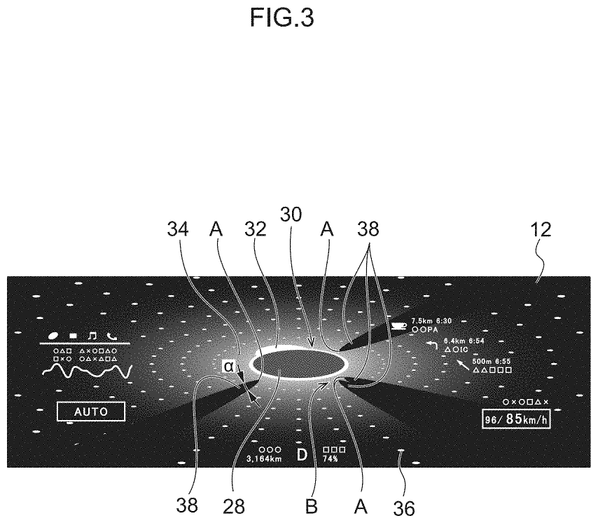

The warning direction display 30 is displayed in a ring shape around an outer edge of the own-vehicle display 28 at the outer side of the own-vehicle display 28. As an example, the warning direction display 30 is displayed with a greater brightness than the own-vehicle display 28. As illustrated in FIG. 2, the warning direction display 30 includes an emphatic display section 32 where a part of the warning direction display 30 in the circumferential direction extends toward a radial direction outside centered on the own-vehicle display 28. The emphatic display section 32 is capable of moving around the outer edge of the own-vehicle display 28 according to a detection result of the detection device 14 (see FIG. 3). There are cases in which the emphatic display section 32 is not displayed, depending on the detection result of the detection device 14.

Nearby Situation Display

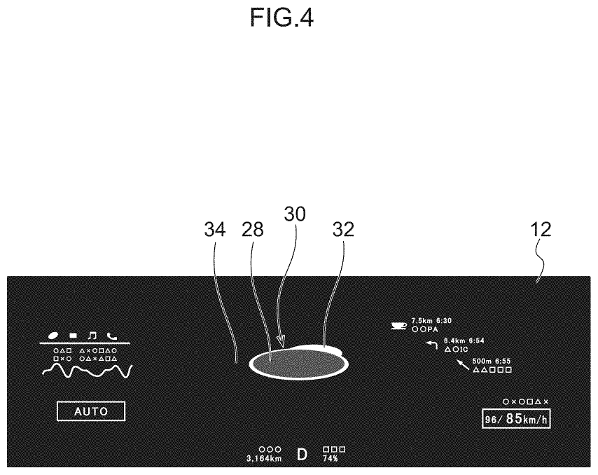

The nearby situation display 34 is displayed at the outer side of the warning direction display 30. As an example, the nearby situation display 34 is centered on the warning direction display 30, is displayed in a single color, and is displayed in a gradated tone that becomes paler in stages on progression away from the warning direction display 30. The color of the nearby situation display 34 is set so as to change in response to a situation nearby the vehicle, as determined by the controller 16. As an example, in cases in which there are few potential hazards, such as other vehicles, requiring caution nearby the vehicle, the nearby situation display 34 is displayed in blue to indicate that a desirable state is present nearby the vehicle. In contrast thereto, in cases in which there are several potential hazards nearby the vehicle, the nearby situation display 34 is displayed in yellow to indicate that a state in which caution is required is present nearby the vehicle. Note that in cases in which there are numerous potential hazards nearby the vehicle, the nearby situation display 34 is displayed in red with no gradation (see FIG. 4), to indicate a state in which the judgement of the occupant is required.

Plural dots 36 are displayed on the nearby situation display 34. The brightness of the dots 36 is set higher than at other locations of the nearby situation display 34, and the dots 36 are displayed distributed on plural concentric circles centered on the own-vehicle display 28.

In cases in which there is a potential hazard present nearby the vehicle and the potential hazard has been detected by the surroundings monitoring device 10, the potential hazard display 38 is displayed on the nearby situation display 34. The brightness of the potential hazard display 38 is set lower than that of the nearby situation display 34. The potential hazard display 38 is displayed so as to appear as a shadow that widens on progression from an apex point A displayed close to the own-vehicle display 28 toward a location of the display panel 12 corresponding to a direction in which the potential hazard is present relative to the vehicle. Thus, when the potential hazard display 38 is displayed, the nearby situation display 34 has a shape including what appears to be a missing portion. Namely, the shape of the nearby situation display 34 is modified by the potential hazard display 38. Note that the present exemplary embodiment is configured such that potential hazard displays 38 are not displayed in a state in which the judgement of the occupant is required due to there being numerous potential hazards nearby the vehicle, as described above. However, the potential hazard displays 38 may also be displayed in this state. The vehicle front-rear direction of the vehicle is displayed in the vehicle vertical direction on the display panel 12, and the vehicle width direction of the vehicle is displayed in the vehicle width direction on the display panel 12. As an example, in cases in which a potential hazard is present at the vehicle front side of the vehicle, the vehicle upper side of the own-vehicle display 28 on the display panel 12 corresponds to the above-described “location of the display panel 12 corresponding to a direction in which the potential hazard is present relative to the vehicle”. Similarly, in cases in which a potential hazard is present at the vehicle rear side of the vehicle, the vehicle lower side of the own-vehicle display 28 on the display panel 12 corresponds to the “location of the display panel 12 corresponding to a direction in which the potential hazard is present relative to the vehicle”. Similarly, with respect to the vehicle width direction, in cases in which a potential hazard is present at the vehicle right side of the vehicle, the right side of the own-vehicle display 28 on the display panel 12, and in cases in which a potential hazard is present at the vehicle left side of the vehicle, the left side of the own-vehicle display 28 on the display panel 12, correspond to the above-described “location of the display panel 12 corresponding to a direction in which the potential hazard is present relative to the vehicle.”

In each of the potential hazard displays 38, the apex point A close to the own-vehicle display 28 is set such that an angle α is modified according to a potential degree of influence of the potential hazard on the vehicle. As an example, in cases in which the potential hazard display 38 corresponds to a potential hazard that has a high speed relative to the vehicle and so has a large potential influence on the vehicle, as illustrated in FIG. 3, the angle α of the apex point A is configured so as to display a small shape, namely, a sharp shape. In contrast thereto, in cases in which the potential hazard display 38 corresponds to a potential hazard that has a low speed relative to the vehicle and so has a small potential influence on the vehicle, as illustrated in FIG. 2, the angle α of the apex point A configured so as to display a large shape, namely, a rounded shape. Note that although the angle α is set so as to be modified according to the speed of the potential hazard relative to the vehicle in the present exemplary embodiment, there is no limitation thereto. The angle α may be set so as to be modified according to another parameter, such as the size of an angle formed between the direction of travel of the vehicle and the direction of travel of the potential hazard. A potential hazard display 38 is displayed for each potential hazard. As an example, in cases in which two potential hazards are present close to each other, the potential hazard displays 38 corresponding to the respective potential hazards are displayed superimposed on each other in a state in which the respective apex points A are slightly offset from each other (see region B in FIG. 3).

The display panel 12 includes a command display section 40 that displays commands input by an occupant during autonomous driving. Namely, as an example, when the occupant inputs a preset overtake command in order that the vehicle overtake another vehicle traveling ahead during autonomous driving, an overtake mark 42 is displayed on the command display section 40. At the same time, an image 44 captured by the detection device 14 on the side where the course of travel is to change when overtaking (the right side in the present exemplary embodiment) is displayed on the display panel 12 alongside the own-vehicle display 28 (on the right side in the present exemplary embodiment as an example, this lying in the same direction as the side where the course of travel is to change). The occupant is thereby able to easily ascertain that monitoring is being performed on the side where the vehicle is to make a lane change during overtaking.

Controller

The controller 16 illustrated in FIG. 1 is configured including a control Electronic Control Unit (ECU) and a navigation system. The control ECU and the navigation system are each connected to an onboard network such as a Controller Area Network (CAN). The controller 16 is connected to the detection device 14 via the onboard network.

The detection device 14 detects the situation in the surroundings of the vehicle. The detection device 14 includes at least one out of a camera, radar, or Laser Imaging Detection and Ranging (LIDAR). For example, a camera is provided at the cabin interior side of an upper portion of the vehicle front windshield, and acquires captured image information by capturing images of the situation outside the vehicle. The camera is capable of transmitting the acquired captured image information to the control ECU of the controller 16 connected to the onboard network. The camera may be a monocular camera or a stereo camera. In the case of a stereo camera, the camera includes two imaging units disposed so as to replicate binocular disparity. The captured image information of the stereo camera includes information in a depth direction. In the case of radar, electromagnetic waves (for example millimeter waves) are transmitted toward the vicinity of the vehicle, and electromagnetic waves reflected by a potential hazard are received to detect the potential hazard. Information regarding the detected potential hazard can be transmitted to the control ECU of the controller 16 connected to the onboard network. In the case of LIDAR, light is transmitted toward the vicinity of the vehicle, and light reflected by a potential hazard is received to measure the distance to the reflection point and to detect the potential hazard. Information regarding the detected potential hazard acquired by LIDAR can be transmitted to the control ECU of the controller 16 connected to the onboard network. Note that it is not necessary to provide more than one out of a camera, LIDAR, or radar.

The navigation system indicates a route to a destination set by an occupant of the vehicle. The navigation system computes a route for the vehicle to travel on based on vehicle position information measured by a GPS receiver and map information held in a map database. The route may specify an optimal traffic lane on sections with plural traffic lanes. For example, the navigation system computes a target route from the vehicle position to the destination, and notifies the occupant of the target route by display on the display panel 12 and audio output from a speaker. The navigation system is capable of transmitting information regarding the target route of the vehicle to the control ECU connected to the onboard network. Note that a navigation system function may be stored in a computer at a facility such as an information processing center that is capable of communicating with the vehicle.

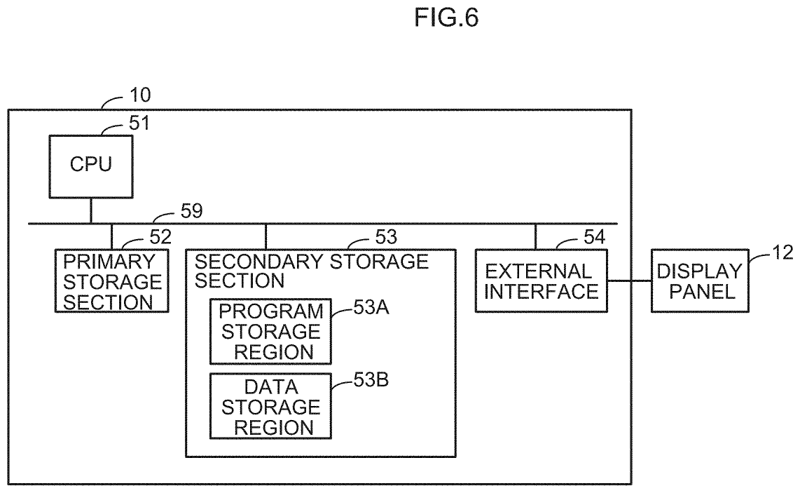

FIG. 6 illustrates an example of a hardware configuration of the control ECU of the controller 16. The control ECU includes a CPU 51, this being an example of a hardware processor, a primary storage section 52, a secondary storage section 53, and an external interface 54.

The primary storage section 52 is configured by volatile memory such as Random Access Memory (RAM). The secondary storage section 53 is configured by non-volatile memory such as Read Only Memory (ROM), a Hard Disk Drive (HDD), or a Solid State Drive (SSD).

The secondary storage section 53 includes a program storage region 53A and a data storage region 53B. As an example, the program storage region 53A stores a program such as a surroundings monitoring program that causes the CPU 51 to execute surroundings monitoring processing. The data storage region 53B stores data acquired by the detection device 14, temporary intermediate data generated during surroundings monitoring processing, and so on.

The CPU 51 reads the surroundings monitoring program from the program storage region 53A and expands the program in the primary storage section 52. By loading and executing the surroundings monitoring program, the CPU 51 operates as the control ECU of the controller 16 in FIG. 1. Note that a program such as the surroundings monitoring program may be stored on a non-transitory recording medium such as a Digital Versatile Disc (DVD), read using a recording medium reader, and expanded into the primary storage section 52.

An external device is connected to the external interface 54. The external interface 54 exchanges various information between the external device and the CPU 51. For example, the control ECU is connected to the display panel 12 through the external interface 54.

Control Flow

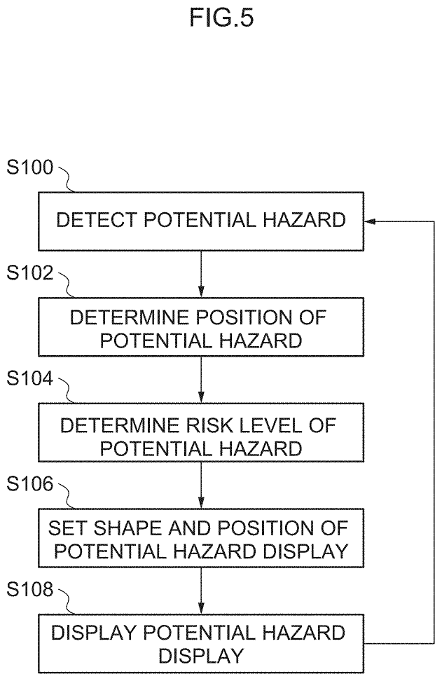

Explanation follows regarding a flow of surroundings monitoring processing, with reference to FIG. 5. As illustrated in FIG. 5, at step S100, the controller 16 detects potential hazards present nearby the vehicle based on a detection result of the detection device 14.

At step S102, the controller 16 computes and determines the position of each detected potential hazard relative to the vehicle based on the detection result from the detection device 14. At step S104, the risk level of each detected potential hazard is determined. The risk levels are proportional potential degrees of influence on the vehicle, determined based on combined factors including the movement direction of the potential hazard, the speed of the potential hazard relative to the vehicle, and so on.

At step S106, the position of each potential hazard display 38 relative to the own-vehicle display 28 on the display panel 12 and the angle α of the apex point A of each potential hazard display 38 on the display panel 12 are set based on the risk level of the corresponding potential hazard as determined at step S104. At step S108, the potential hazard display 38 is displayed on the display panel 12. The control from step S100 to step S108 described above is performed repeatedly. At the same time, the controller 16 detects the potential hazard that has the greatest potential influence on the vehicle (hereafter referred to as the greatest potential hazard) from out of the potential hazards present nearby the vehicle, based on the detection result from the detection device 14. As an example, the greatest potential hazard is the object that has the greatest potential influence on the vehicle from out other vehicles, pedestrians, bicycles, obstacles, and so on present close to the vehicle, as detected based on combined factors including the movement directions relative to the vehicle, the speeds relative to the vehicle, and so on. The controller 16 then computes and determines the position of the detected greatest potential hazard relative to the vehicle based on the detection result from the detection device 14. The position of the emphatic display section 32 relative to the own-vehicle display 28 on the warning direction display 30 of the display panel 12 is set, and the emphatic display section 32 is displayed on the display panel 12 (see FIG. 2, FIG. 3) based on the position of the greatest potential hazard.

Namely, in cases in which the greatest potential hazard is at the vehicle front side of the vehicle, the emphatic display section 32 is displayed at the vehicle upper side of the own-vehicle display 28 on the display panel 12. Similarly, in cases in which the greatest potential hazard is at the right side of the vehicle, the emphatic display section 32 is displayed at the right side of the own-vehicle display 28 on the display panel 12. At the same time, potential hazards other than the greatest potential hazard are also displayed as potential hazard displays 38. This enables the occupant to intuitively ascertain the position of the greatest potential hazard based on the position of the emphatic display section 32 on the display panel 12, and the occupant is also able to intuitively ascertain the positions of other potential hazards and their potential degrees of influence relative to the vehicle based on the potential hazard displays 38. Note that in cases in which numerous potential hazards are present, as illustrated in FIG. 4, the nearby situation display 34 and the dots 36 are placed in a non-displayed (hidden) state by the potential hazard displays 38. The occupant can thereby quickly be made aware that a state has arisen in which the greatest level of caution is required.

### Operation and Advantageous Effects of Exemplary Embodiment

Explanation follows regarding the operation and advantageous effects of the present exemplary embodiment.

As illustrated in FIG. 1, in the present exemplary embodiment, the surroundings monitoring device 10 includes the display panel 12, the detection device 14, and the controller 16. The display panel 12 includes the own-vehicle display 28 that represents the vehicle. The detection device 14 detects potential hazards present nearby the vehicle. The controller 16 displays potential hazard displays 38 on the display panel 12. As illustrated in FIG. 3, each potential hazard display 38 is displayed spanning from close to the own-vehicle display 28 to a location on the display panel 12 corresponding to the direction in which the potential hazard is present, and is distinct from display at other locations. Thus, a direction in which caution is required due to the presence of a potential hazard is indicated in a simple manner by the orientation of the potential hazard display 38, thereby enabling the occupant to intuitively ascertain the direction of the potential hazard detected by the detection device 14. This enables the occupant to intuitively ascertain the presence of a potential hazard detected by the detection device 14 and the direction of this potential hazard.

The controller 16 modifies the shape of the potential hazard display 38 displayed on the display panel 12 to indicate the direction of a potential hazard according to the situation. Specifically, in cases in which the potential hazard has a high potential degree of influence on the vehicle, the potential hazard display 38 is displayed as a sharp shape. Note that in cognitive psychology, the “bouba/kiki effect” regarding generally observed inferred relationships between speech sounds and the visual impression of graphics suggests that when a person sees a sharp shape, the person is generally more likely to infer that a dangerous state has arisen and that caution is required. Thus, modifying the potential hazard display 38 to a sharp shape in cases in which the potential hazard has a high potential degree of influence on the vehicle enables the occupant to be made to intuitively ascertain that caution is required. This enables the occupant to intuitively ascertain the direction of a potential hazard with a high potential degree of influence on the vehicle.

The controller 16 also displays the nearby situation display 34 nearby the own-vehicle display 28 on the display panel 12. The display of the nearby situation display 34 is modified according to the situation nearby the vehicle as determined by the controller 16. The occupant is thereby able to ascertain the situation nearby the vehicle easily based on this display state. Moreover, the shape of the nearby situation display 34 changes according to the potential hazard displays 38, thereby enabling the occupant to intuitively ascertain the situation nearby the vehicle, including the directions of potential hazards and the potential degrees of influence of the potential hazards on the vehicle. This enables the occupant to intuitively ascertain the situation nearby the vehicle.

Furthermore, plural dots are displayed on the nearby situation display 34, and these dots are not displayed in locations where a potential hazard display 38 is being displayed. It is therefore easy to distinguish between locations where a potential hazard display 38 is being displayed and other locations. Namely, this enables the display on the display panel 12 to be more easily understood. This enables the occupant to more intuitively ascertain the presence of potential hazards detected by the detection device 14, the directions of these potential hazards, and the direction of a large potential influence on the vehicle.

Note that although the own-vehicle display 28 is displayed in an elliptical shape in the present exemplary embodiment, there is no limitation thereto. The own-vehicle display 28 may be displayed in another shape, such as a rectangular shape.

Although the display panel 12 is configured as a liquid crystal panel provided to the meter cluster 20, there is no limitation thereto. The display panel 12 may have another configuration, such as a head-up display.

Although the operation status of the surroundings monitoring device 10 is displayed on the display panel 12 by the own-vehicle display 28, the warning direction display 30, and the nearby situation display 34, there is no limitation thereto. A configuration may be applied in which the warning direction display 30 is not displayed.

Although the nearby situation display 34 is displayed in blue, yellow, or red according to the situation nearby the vehicle as determined by the controller 16, there is no limitation thereto. The nearby situation display 34 may be displayed using other colors.

Although the emphatic display section 32 of the warning direction display 30 is displayed such that a part of the warning direction display 30 in the circumferential direction extends toward a radial direction outside centered on the own-vehicle display 28, there is no limitation thereto. The emphatic display section 32 may be displayed in another shape, such as an arrow.

Although the surroundings monitoring device 10 is applied to a vehicle capable of autonomous driving, there is no limitation thereto. The surroundings monitoring device 10 may be applied to another vehicle in which an occupant drives by hand.

Although the potential hazard display 38 is displayed as a shadow, there is no limitation thereto. The potential hazard display 38 may be displayed with higher brightness than other locations, or may be displayed using another graphic such as an arrow.

Although the apex point A of the potential hazard display 38 is displayed close to the own-vehicle display 28, there is no limitation thereto. The apex point A may be displayed so as to touch the edge of the own-vehicle display 28, or may be displayed so as to be superimposed on the own-vehicle display 28.

Although the vehicle front-rear direction of the vehicle is displayed in the vehicle vertical direction on the display panel 12, and the vehicle width direction of the vehicle is displayed in the vehicle width direction on the display panel 12, there is no limitation thereto. These directions may be respectively displayed in different directions on the display panel 12.

An exemplary embodiment of the present disclosure has been described above. However, the present disclosure is not limited to the above description, and various other modifications may be implemented within a range not departing from the spirit of the present disclosure.

An object of the present disclosure is to enable an occupant to intuitively ascertain a potential hazard that has been detected by a detection device and the direction of the potential hazard.

A first aspect is a surroundings monitoring device that includes: a display device that displays an own-vehicle display displaying a vehicle equipped with the surroundings monitoring device; a detection device that detects a potential hazard present near the vehicle; a processor; and a memory that is connected to the processor, the processor being configured to display on the display device a potential hazard display spanning from the own-vehicle display, or from a vicinity of the own-vehicle display on the display device, to a location of the display device corresponding to a direction in which the potential hazard detected by the detection device is present, the potential hazard display being distinct from display at other locations.

According to the first aspect, the display device performs the own-vehicle display that represents the vehicle. The detection device detects a potential hazard present nearby the vehicle. The processor displays the potential hazard display on the display device. The potential hazard display is displayed on the display device spanning from the own-vehicle display or from close to the own-vehicle display to a location corresponding to the direction in which the potential hazard is present, and the potential hazard display is distinct from display at other locations. Thus, a direction in which caution is required due to the presence of the potential hazard is indicated in a simple manner by the orientation of the potential hazard display, thereby enabling the occupant to intuitively ascertain the direction of the potential hazard detected by the detection device.

A second aspect is the surroundings monitoring device of the first aspect, wherein: the processor is configured to display the potential hazard display displayed on the display device as a sharp shape, in a case in which the potential hazard has a high potential degree of influence on the vehicle.

According to the second aspect, the processor modifies the shape of the potential hazard display displayed on the display device to indicate the direction of a potential hazard according to the situation. Specifically, in cases in which the potential hazard has a high potential degree of influence on the vehicle, the potential hazard display is displayed as a sharp shape. When a person sees an object with a sharp shape, the person is generally more likely to infer that a dangerous state has arisen and that caution is required. Thus, modifying the potential hazard display to a sharp shape in cases in which the potential hazard has a high potential degree of influence on the vehicle enables intuitive recognition that caution is required.

Here, a “sharp shape” refers to a shape including an acute angle, or a shape including a rounded portion with a radius small enough to appear angular.

A third aspect is the surroundings monitoring device of the first or the second aspect, wherein: the processor is configured to display a nearby situation display near the own-vehicle display on the display device, a display of the nearby situation display being modified according to a situation near the vehicle as determined by the processor, and having a shape that is modified by the potential hazard display.

According to the third aspect, the processor displays the nearby situation display nearby the own-vehicle display on the display device. The display of the nearby situation display is modified according to the situation nearby the vehicle as determined by the processor. The occupant is thereby able to ascertain the situation nearby the vehicle easily based on this display state. Moreover, the shape of the nearby situation display changes according to the potential hazard display, thereby enabling the occupant to intuitively ascertain the situation nearby the vehicle, including the direction of a potential hazard and the potential degree of influence of the potential hazard on the vehicle.

A fourth aspect is the surroundings monitoring device of the third aspect, wherein: a plurality of dots are displayed on the nearby situation display, while the dots are not displayed at a location where the potential hazard display is being displayed.

According to the fourth aspect, the plural dots are displayed on the nearby situation display, and these dots are not displayed at the location where the potential hazard display is being displayed. It is therefore easy to distinguish between the locations where the potential hazard display is being displayed and other locations. Namely, this enables the display on the display device to be more easily understood.

The surroundings monitoring device of the first aspect enables an occupant to intuitively ascertain the presence of a potential hazard detected by the detection device and to ascertain the direction of the potential hazard.

The surroundings monitoring device of the second aspect enables an occupant to intuitively ascertain the direction of a potential hazard with a high potential degree of influence on the vehicle.

The surroundings monitoring device of the third aspect enables an occupant to intuitively ascertain the situation nearby the vehicle.

The surroundings monitoring device of the fourth aspect enables more intuitive recognition of the presence of potential hazards detected by the detection device, the directions of these potential hazards, and the direction of a large potential influence on the vehicle.

What is claimed is:

1. A surroundings monitoring device comprising:
a display device that displays an own-vehicle display displaying a vehicle equipped with the surroundings monitoring device;
a detection device that detects a potential hazard present near the vehicle;
a processor; and
a memory that is connected to the processor,
the processor being configured to display on the display device a potential hazard display spanning from the own-vehicle display, or from a vicinity of the own-vehicle display on the display device, to a location of the display device corresponding to a direction in which the potential hazard detected by the detection device is present, the potential hazard display being distinct from display at other locations.

2. The surroundings monitoring device of claim 1, wherein:
the processor is configured to display the potential hazard display displayed on the display device as a sharp shape, in a case in which the potential hazard has a high potential degree of influence on the vehicle.

3. The surroundings monitoring device of claim 1, wherein:
the processor is configured to display a nearby situation display near the own-vehicle display on the display device, a display of the nearby situation display being modified according to a situation near the vehicle as determined by the processor, and having a shape that is modified by the potential hazard display.

4. The surroundings monitoring device of claim 3, wherein:
a plurality of dots are displayed on the nearby situation display, while the dots are not displayed at a location where the potential hazard display is being displayed.

5. A surroundings monitoring method comprising:
by a processor,
determining a position of a potential hazard relative to a vehicle based on a detection result from a detection device that detects potential hazards present near the vehicle; and
based on a result of the determination, displaying, on a display device that displays an own-vehicle display displaying the vehicle, which performs the surroundings monitoring method, a potential hazard display spanning from the own-vehicle display, or from a vicinity of the own-vehicle display on the display device, to a location of the display device corresponding to a direction in which the potential hazard is present, the potential hazard display being distinct from display at other locations.

6. The surroundings monitoring method of claim 5, wherein:
in a case in which the potential hazard has a high potential degree of influence on the vehicle, the potential hazard display displayed on the display device is configured as a sharp shape.

7. The surroundings monitoring method of claim 5, wherein:
a nearby situation display is displayed near the own-vehicle display on the display device, a display of the nearby situation display being modified according to a situation near the vehicle, and having a shape that is modified by the potential hazard display.

8. The surroundings monitoring method of claim 7, wherein:
a plurality of dots are displayed on the nearby situation display, while the dots are not displayed at a location where the potential hazard display is being displayed.

9. A non-transitory recording medium storing a program that is executable by a computer to perform surroundings monitoring processing, the surroundings monitoring processing comprising:
determining a position of a potential hazard relative to a vehicle based on a detection result from a detection device that detects potential hazards present near the vehicle; and
based on a result of the determination, displaying, on a display device that displays an own-vehicle display displaying the vehicle, a potential hazard display spanning from the own-vehicle display, or from a vicinity of the own-vehicle display on the display device, to a location of the display device corresponding to a direction in which the potential hazard is present, the potential hazard display being distinct from display at other locations.

10. The non-transitory recording medium of claim 9, wherein
in a case in which the potential hazard has a high potential degree of influence on the vehicle, the potential hazard display displayed on the display device is configured as a sharp shape.

11. The non-transitory recording medium of claim 9, wherein
a nearby situation display is displayed near the own-vehicle display on the display device, a display of the nearby situation display being modified according to a situation near the vehicle, and having a shape that is modified by the potential hazard display.

12. The non-transitory recording medium of claim 11, wherein
a plurality of dots are displayed on the nearby situation display, while the dots are not displayed at a location where the potential hazard display is being displayed.
